(19) United States
(12) Patent Application Publication
(10) Pub. No.: US 2008/0150611 A1
(43) Pub. Date: Jun. 26, 2008

(54) System for connecting a sensor to a controller

(76) Inventors: Robert J. Disser, Dayton, OH (US); Paul Degoul, (US)

Correspondence Address: DELPHI TECHNOLOGIES, INC., M/C 480-410-202, PO BOX 5052, TROY, MI, 48007, US

(21) Appl. No.: 11/999,789

(22) Filed: Dec. 7, 2007

Related U.S. Application Data
(60) Provisional application No. 60/876,900, filed on Dec. 22, 2006.

(51) Int. Cl. G05B 11/01

(52) U.S. Cl. 327/518

(57) ABSTRACT

A sensor to controller connection system including a power source, a controller in communication with the power source, and a sensor in communication with the power source and the controller, the sensor including sensor electronics and a current source, the current source having a control input and an output, the control input being applied by the sensor electronics and the output being applied to the controller, wherein the current source controls an electric signal communicated to the controller from the sensor based upon the control input.

The present application claims priority from U.S. Ser. No. 60/876,900 filed on Dec. 22, 2006, the entire contents of which are incorporated herein by reference.

### BACKGROUND

The present application relates to systems for connecting remote sensors to electronic controllers and, more particularly, to systems for connecting remote sensors to electronic controllers having a single wire connection and improved signal to noise immunity.

Referring to FIG. 1, a typical prior art sensor to controller connection system, generally designated 10, includes a remote sensor 12, an electronic controller 14 and a battery 16 and is connected to ground 18. The wiring inductance L_{W}, wiring resistance R_{W} and current noise source N of the system 10 represent ground noise created by transient currents in the ground path of the controller 14. For example, a controller powering a motor load (not shown) may experience ground noise in excess of about 1 V (positive or negative).

The input signal from the sensor 12 to the controller 14 is typically a relatively high impedance signal that does not allow significant current flow and, therefore, is sensitive to noise. For example, an input signal of 0.5 V to the sensor 12 may facilitate a current flow of only about 50 microamps, which is sufficiently low to be subject to ground noise. Therefore, to minimize the ground noise interference with the signal generated by the sensor 12, a three wire connector 20 (e.g., a three pin connector) is used to supply power, by way of battery 16 and voltage regulator 17, and ground to the sensor 12 from the controller 14 over first and second wires 22, 24, while the sensor 12 supplies a signal to the controller 14 over the third wire 26. Ideally, the three wires 22, 24, 26 are twisted together to minimize external electrical interference.

Thus, the three wire system of FIG. 1 requires increased wiring and connector cost and a significant amount of care to reduce signal noise issues.

Referring to FIG. 2, a first alternative prior art sensor to controller connection system, generally designated 50, includes a remote sensor 52, an electronic controller 54 and a battery 56 and is connected to ground 58. The wiring inductance L_{W}, wiring resistance R_{W} and current noise source N of the system 50 represent ground noise created by transient currents in the ground path of the controller 54.

The sensor 52 includes a voltage regulator 60 and a pulse width modulation (“PWM”) generator 62 and may be directly connected to the battery 56 and ground 58 (e.g., by way of lines 63, 64, respectively). The voltage regulator 60 regulates the battery voltage to the desired output voltage V_{OUT}, thereby applying the proper voltage to the potentiometer R_{S} of the sensor 52. The PWM generator 62 converts the analog sensor signal from the potentiometer R_{S} to a pulse width modulated signal and communicates the pulse width modulated sensor signal to the controller 54. The duty cycle of the pulse width modulated sensor signal is proportional to the value of the analog sensor signal value.

Thus, the connection between the sensor 52 and the controller 54 may be a single wire. Alternatively, as shown by broken line 66, the sensor 52 may be connected to ground 58 by way of a second wire connection between the sensor 52 and the controller 54, thereby requiring two wires between the sensor 52 and the controller 54. Nonetheless, with either a one or two wire connection, design consideration must be given to valid signal voltages such that the signal is guaranteed to be received even in the event of large ground noise transients. Furthermore, a second design consideration requires that the input interface circuit in the controller must not adjust the PWM duty cycle of the sensor signal prior to a microprocessor reading the signal and a third design consideration is the amount of microprocessor throughput which must be used to calculate the PWM duty cycle. Still furthermore, many microprocessors must receive an interrupt at each edge of the pulse width modulated sensor signal to calculate the duty cycle of the signal. Therefore, to transmit a higher bandwidth signal, the PWM frequency must also be higher, which increases the number of microprocessor interrupts and increases the microprocessor throughput utilized to calculate the PWM duty cycle.

A second alternative prior art sensor to controller connection system (not shown) is a single wire signal solution that sources a current between 4 mA and 20 mA proportional to the linear signal, wherein 4 mA represents no signal and 20 mA represents maximum signal. To provide a signal current of this magnitude requires significant power dissipation in the transistor which supplies the current, which may become cost prohibitive in the automotive environment.

Accordingly, there is a need for a system for communicating a sensor signal between a sensor and a controller having improved signal to noise immunity and a single wire or pin connection between the sensor and the controller.

### SUMMARY

In one aspect, the disclosed sensor to controller connection system may include a power source, a controller in communication with the power source, and a sensor in communication with the power source and the controller, the sensor including sensor electronics and a current source, the current source having a control input and an output, the control input being applied by the sensor electronics and the output being applied to the controller, wherein the current source controls an electric signal communicated to the controller from the sensor based upon the control input.

In another aspect, the disclosed sensor to controller connection system may include a battery, a controller in communication with the battery, and a sensor in communication with the controller by way of a single wire connection, the sensor including sensor electronics, a current source and a voltage regulator, the voltage regulator being in communication with the battery and the current source, the current source having a control input and an output, wherein the control input includes a voltage applied by the sensor electronics, and wherein the output controls an electric current communicated to the controller from the sensor.

Other aspects of the disclosed system for connecting a sensor to a controller will become apparent from the following description, the accompanying drawings and the appended claims.

### BRIEF DESCRIPTION OF THE DRAWINGS

FIG. 1 is a schematic illustration of a first prior art sensor to controller connection system;

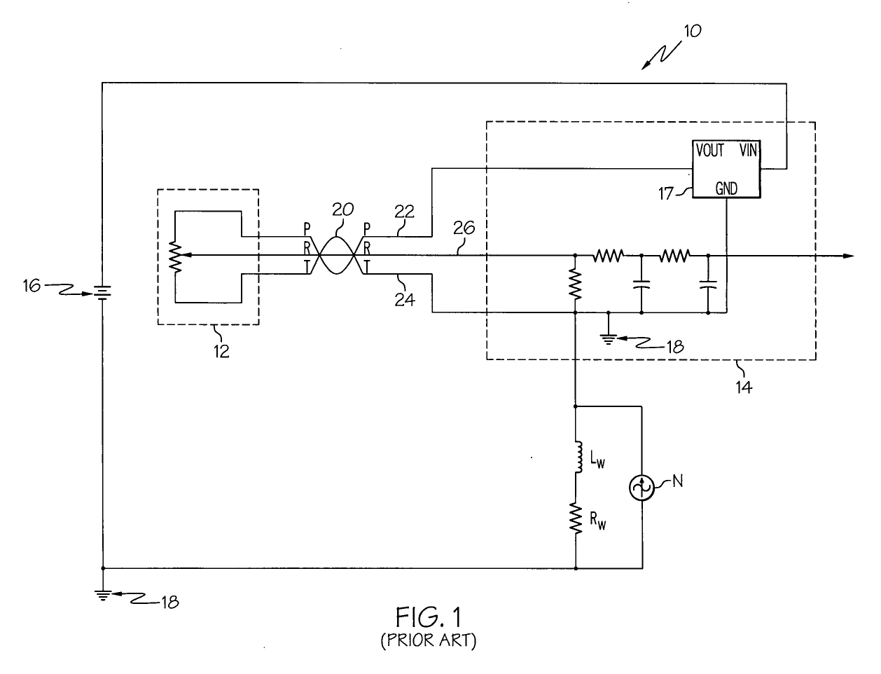

FIG. 2 is a schematic illustration of a second prior art sensor to controller connection system;

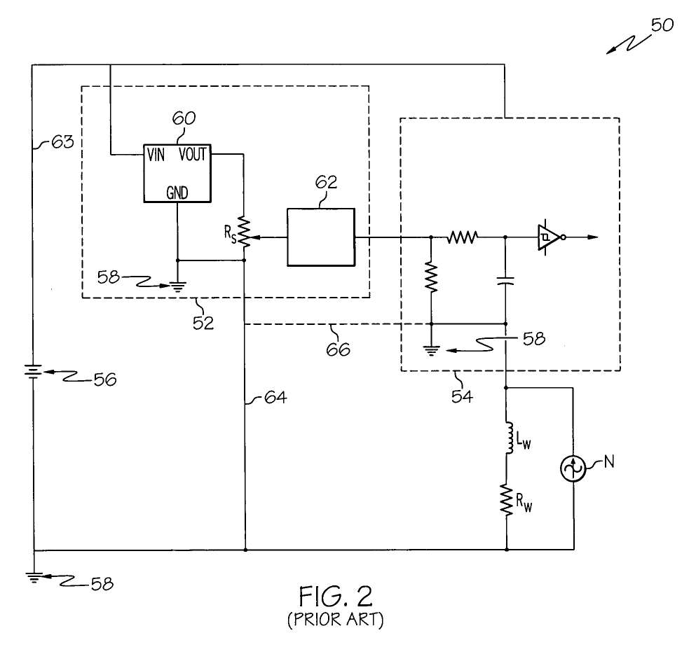

FIG. 3 is a schematic illustration of a first aspect of the disclosed system for connecting a sensor to a controller; and

FIG. 4 is a schematic illustration of a sensor according to a second aspect of the disclosed system for connecting a sensor to a controller.

### DETAILED DESCRIPTION

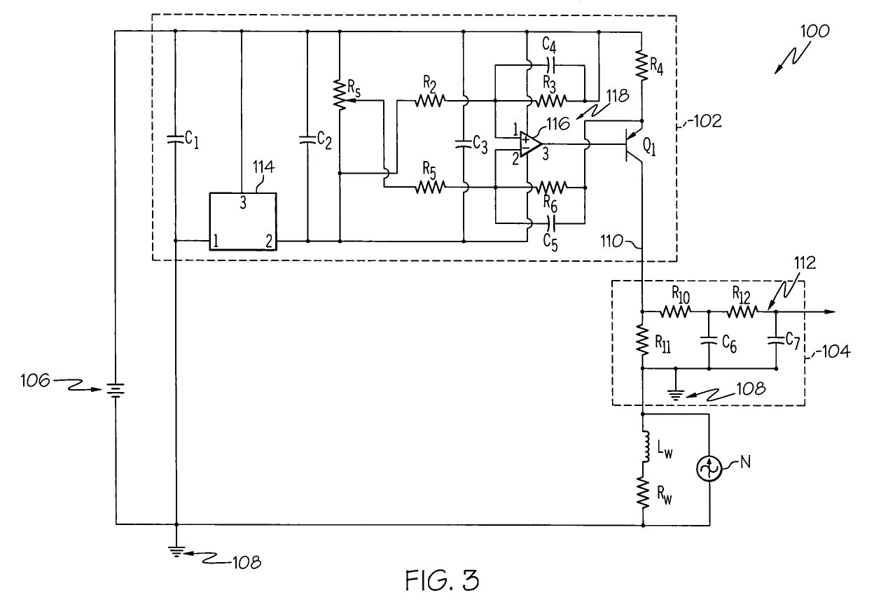

Referring to FIG. 3, one aspect of the disclosed system for connecting a sensor to a controller, generally designated 100, may include a sensor 102, an electronic controller 104 and a power source 106, such as a battery (e.g., a 12 V automotive battery). The system 100 may be connected to ground 108, such as a vehicle chassis. The wiring inductance L_{W}, wiring resistance R_{W} and current noise source N of the system 100 may represent ground noise created by transient currents in the ground path of the controller 104.

In one aspect, sensor 102 may be a pedal feel emulator (not shown) that indicates a driver's brake request and the controller 104 may be associated with a front right electric caliper (not shown) and may generate and communicate a braking signal to the caliper based upon signals received from the pedal feel emulator.

The controller 104 may include resistors R₁₀, R₁₁, R₁₂ and capacitors C₆, C₇. The input to the controller 104 from the sensor 102 may be in the form of a single wire 110 that supplies a current. For example, a single pin connector may be used to connect the sensor 102 to the controller 104. The use of a single wire connection between the sensor 102 and the controller 104 may provide several advantages, including reduced costs and manufacturing time. The current supplied by the wire 110 may be converted to a signal voltage by resistor R₁₁, which may be filtered by a low pass filter 112 created by resistors R₁₀, R₁₂ and capacitors C₆, C₇. The low pass filter 112 may eliminate signal noise and may provide an anti-aliasing filter.

The sensor 102 may include a potentiometer R_{S}, resistors R₂, R₃, R₄, R₅, R₆, capacitors C₁, C₂, C₃, C₄, C₅, a transistor Q₁, a voltage regulator 114 and an integrated circuit 116. The potentiometer R_{S} may represent the sensor function of the sensor 102 and may be capable of supplying a voltage corresponding to a sensor input (e.g., pedal travel). However, those skilled in the art will appreciate that sensor 102 may have various sensor inputs. The integrated circuit 116, resistors R₂, R₃, R₅, R₆ and capacitors C₄, C₅ may form a differential amplifier, generally designated 118. The differential amplifier 118 and the transistor Q₁ may function as a current source.

The voltage regulator 114 of the sensor 102 may be connected to the positive terminal of the power source 106 at pin 3 of the regulator 114 and to ground 108 at pin 1 of the regulator 114. For example, the power source 106 may apply 12 V to the sensor 102 and the voltage regulator 114 may regulate the applied voltage to 5 V. The regulated output voltage (pin 2) from the regulator 114 may be applied to the potentiometer R_{S} and the first input (pin 1) of the amplifier 118. The output of the potentiometer R_{S} may be applied to the second input (pin 2) of the amplifier 118. The resulting output (pin 3) of the amplifier 118 may control the transistor Q₁, thereby regulating the current output to the controller 104 by way of line 110.

In one aspect, unlike conventional sensors that operate from 0 V to 5 V, sensor 102 may operate from 7 V to 12 V with respect to ground 108. The standard acceptable automotive battery voltage range is 9 V to 16 V. For example, when the power source 106 is a battery sourcing 16 V, the sensor 102 may operate between 11 V and 16 V with respect to ground 108. When the battery 106 is sourcing 9 V, the sensor 102 may operate between 4 V and 9 V with respect to ground 108. Many automotive manufactures prefer electronic controllers to operate down to a controller voltage of 7 V to account for the transient ground noise. Therefore, to provide a valid signal, transistor Q₁ may source current to the controller 104 and remain in the active linear conduction range which requires a collector emitter voltage of greater than 0.5 V. When the maximum voltage across resistor R₄ is designed to be 1 V, the output voltage of the sensor 102 may be within 1.5 V of the positive battery voltage and the maximum signal generated across resistor R₁₁ in the controller is 5 V. With 1.5 V across the sensor output and 5 V across the controller signal input, the sensor system 100 can operate with a minimum battery voltage of 6.5 V. As the battery voltage rises above 6.5 V, the transistor Q₁ remains in the active linear conduction range, thereby increasing the power dissipation of transistor Q₁.

For cost considerations, the use of small signal transistors instead of power transistors may be preferred. To allow the use of small signal transistors, the maximum current sourced by the sensor interface electronics should be controlled to maintain acceptable power dissipation in transistor Q₁ under maximum battery voltage conditions. To maintain a power dissipation of 50 mW in transistor Q₁ with a 16 V battery, the maximum current that transistor Q₁ can source is 5 mA. Under this system condition, 1 V across resistor R₄ in the sensor interface electronics and 5 V across resistor R₁₁ in the controller leaves 10 V across transistor Q₁.

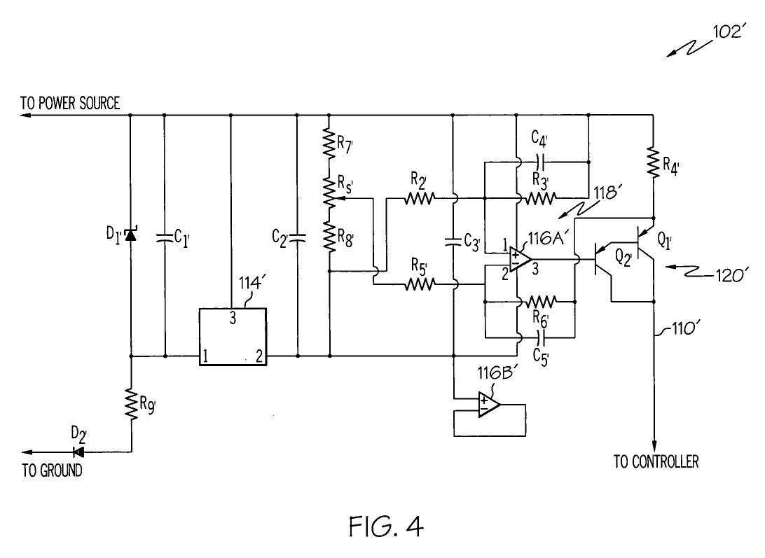

Referring to FIG. 4, one specific aspect of a sensor, generally designated 102′, useful with the system 100 of FIG. 3 may include a potentiometer R_{S}′, resistors R₂′, R₃′, R₄′, R₅′, R₆′, R₇′, R₈′, R₉′, capacitors C₁′, C₂′, C₃′, C₄′, C₅′, transistors Q₁′, Q₂′, diodes D₁′, D₂′, a voltage regulator 114′ and amplifiers 116A′, 116B′ associated with integrated circuit. Amplifier 116B′ may be unused. Diode D₂′ may provide reverse voltage protection for the sensor 102′ and diode D₁′ and resistor R₉′ may provide input voltage transient protection for standard automotive voltage transients. Capacitor C₁′ may filter the input battery supply.

The sensor function of the sensor 102′ may be represented by resistors R₇′, R₈′ and potentiometer R_{S}′. For diagnostic reasons, many automotive sensors provide an output of 0.5 V for a signal representing a zero value and an output of 4.5 V for a signal representing the maximum value. Resistors R₇′, R₈′ provide enough voltage offset such that the full range of potentiometer R_{S}′ is 0.5 V to 4.5 V. At this point, those skilled in the art will appreciate that the actual sensor may be a position sensor, a force sensor, an acceleration sensor or the like and resistors R₇′, R₈′ and potentiometer R_{S}′ have only been used to generally represent sensor electronics.

In one aspect, the voltage regulator 114′ may be connected to the positive input of a power source (e.g., power source 106 in FIG. 3) at pin 3 of the regulator 114′ and to ground (e.g., ground 108 in FIG. 3) at pin 1 of the regulator 114′ such that the regulator 114′ may receive a negative input voltage with respect to the regulator ground pin 3. The voltage output (pin 2) of the regulator 114′ may deliver a regulated output voltage that is, for example, 5 V below the regulator ground pin 3. This regulated voltage may become the common voltage for the sensor 102′ and associated interface electronics. For example, the regulated voltage may be about 4 V to 11 V above the vehicle chassis ground depending upon the battery voltage input. The positive battery input voltage may become the regulated +5 V above the sensor common voltage for the sensor and interface electronics. For the purpose of this description, this voltage will be referred to as +5 V although the actual voltage value is equal to the positive battery voltage with respect to ground. Capacitor C₂′ may filter the output of the 5 V sensor power supply. Capacitor C₃′ may filter the sensor supply locally at the power pins of amplifier 116A′. Therefore, in one aspect, the sensor 102′ may convert a 0 V to 5 V sensor input into a 0 mA to 5 mA sensor signal.

The amplifier 116A′, resistors R₂′, R₃′, R₅′, R₆′ and capacitors C₄′, C₅′ may form a differential amplifier, generally designated 118′. In one aspect, the value of resistor R₂′ may equal the value of resistor R₅′, the value of resistor R₃′ may equal the value of resistor R₆′ and the value of capacitor C₄′ may equal the value of capacitor C₅′, such that the gain of the differential amplifier 118′ may be defined by the ratio of resistor R₃′ to resistor R₂′. For example, resistor R₃′ may have a resistance of 49,900 Ohms and resistor R₂′ may have a resistance of 249,000 Ohms, resulting in a gain of the differential amplifier 118′ of about 0.2 (49,900/249,000). Therefore, in one example, the differential amplifier 118′ may provide an output voltage that is equal to 0.2 times the input voltage.

The output voltage (pin 3) from the differential amplifier 118′ may be converted to a sensor output current by the transistors Q₁′, Q₂′ and the sensor output current may be supplied to the controller (FIG. 3) by line 110′. Transistors Q₁′, Q₂′ may be configured as a Darlington transistor pair 120′, which may be two individual transistors or a single transistor package designed specifically as a Darlington transistor. The collectors of transistors Q₁′, Q₂′ may be the output current source of the sensor 102′ to the controller (FIG. 3). The Darlington transistor configuration 120′ may be used since the collector current of a transistor equals the emitter current minus the base current. Therefore, the Darlington transistor configuration 120′ may increase the gain of the transistors Q₁′, Q₂′ such that the base current is very small with respect to the emitter current. Therefore, the emitter current and collector current are very nearly equal. Resistor R₄′ may be configured to sense and ultimately control the emitter current of transistor Q₁′.

The output voltage from the potentiometer R_{S}′ (e.g., between 0.5 and 4.5 V) may be applied to pin 2 of the differential amplifier 118′. As discussed above, the sensor output voltage range may be, for example, between 0.5 and 4.5 V and, therefore, the input voltage to the differential amplifier 118′ may be, for example, between 0.5 and 4.5 V.

If a sensor voltage of zero volts were possible, the output voltage of the differential amplifier 118′ would be zero. However, since resistor R₃′ is connected to +5 V (with respect to the sensor voltage), the voltage on resistor R₆′ may be +5 V and the output voltage of the differential amplifier 118′ will be at a voltage near +5V such that transistors Q₁′, Q₂′ are in a non-conducting state. With a sensor voltage of 0.5 V applied to the input voltage (pin 2) of the differential amplifier 118′, the output voltage goes lower in voltage below +5 V. This change in voltage causes the amplifier 116A′ to sink current from the base of transistor Q₂′. The emitter of transistor Q₂′ sinks current from the base of transistor Q₁′ which causes current flow in the emitter of transistor Q₁′. This current flow is sensed by resistor R₄′ by creating a voltage as the output voltage of the differential amplifier 118′. The output pin 3 of amplifier 116A′ continues to decrease in voltage until the gain equation (e.g., output voltage=0.2×input voltage) of the differential amplifier 118′ is satisfied. For example, the final voltage across resistor R₄′ with a sensor voltage of 0.5 V is 0.1 V. With the value of resistor R₄′ at 200 Ohms, the emitter current of transistor Q₁′ is 500 microamps, for example. Since the collector current of transistors Q₁′, Q₂′ is nearly equal to the emitter current, the sensor and interface electronics source 500 microamps to the controller (FIG. 3). This current is significantly greater than prior art systems, thereby significantly improving the signal to noise immunity. Similarly, with a sensor voltage of 4.5 V as the input voltage to the differential amplifier 118′, the output voltage of the differential amplifier 118′ across resistor R₄′ is 0.9 V, which, following the example above, sources 4.5 mA to the controller (FIG. 3).

Although various aspects of the disclosed sensor to controller connection system have been shown and described, modifications may occur to those skilled in the art upon reading the specification. The present application includes such modifications and is limited only by the scope of the claims.

What is claimed is:

1. A sensor to controller connection system comprising:
a power source;
a controller in communication with said power source; and
a sensor in communication with said power source and said controller, said sensor including sensor electronics and a current source, said current source having a control input and an output, said control input being applied by said sensor electronics and said output being applied to said controller, wherein said current source controls an electric signal communicated to said controller from said sensor based upon said control input.

2. The system of claim 1 wherein said power source is a battery.

3. The system of claim 1 wherein said current source includes a differential amplifier and a transistor.

4. The system of claim 1 wherein said controller and said sensor are connected to a negative terminal of said power source.

5. The system of claim 1 wherein said communication between said controller and said sensor is made over a single wire.

6. The system of claim 1 wherein said controller includes a low pass filter adapted to process said electric signal.

7. The system of claim 1 wherein said electric signal is an electric current.

8. The system of claim 1 wherein said sensor electronics includes a potentiometer.

9. The system of claim 1 wherein said sensor further includes a voltage regulator in communication with said power source, said current source and ground.

10. The system of claim 9 wherein said voltage regulator provides a regulated voltage to said sensor and said current source at a voltage potential substantially at a positive terminal of said power source.

11. The system of claim 10 wherein said controller monitors said electric signal at a voltage potential substantially at a negative terminal of said power source.

12. The system of claim 9 wherein said voltage regulator provides a regulated voltage to said sensor and said current source at a voltage potential substantially at a negative terminal of said power source.

13. The system of claim 12 wherein said controller monitors said electric signal at a voltage potential substantially at a positive terminal of said power source.

14. The system of claim 1 wherein said sensor is in direct communication with said power source.

15. A sensor to controller connection system comprising:
a battery;
a controller in communication with said battery; and
a sensor in communication with said controller by way of a single wire connection, said sensor including sensor electronics, a current source and a voltage regulator, said voltage regulator being in communication with said battery and said current source, said current source having a control input and an output, wherein said control input includes a voltage applied by said sensor electronics, and wherein said output controls an electric current communicated to said controller from said sensor.

16. The system of claim 15 wherein said current source includes a differential amplifier and a transistor.

17. The system of claim 15 wherein said controller and said sensor are connected to the negative terminal of said battery.

18. The system of claim 15 wherein said sensor electronics includes a potentiometer.

19. The system of claim 15 wherein said sensor is in direct communication with said voltage regulator.

20. The system of claim 15 wherein said battery includes a positive terminal and a negative terminal and said voltage regulator is connected to said positive terminal.

21. The system of claim 20 wherein said controller monitors said electric current at said negative terminal.

22. The system of claim 15 wherein said battery includes a positive terminal and a negative terminal and said voltage regulator is connected to said negative terminal.

23. The system of claim 22 wherein said controller monitors said electric current at said positive terminal.
